(19) United States
(12) Patent Application Publication
(10) Pub. No.: US 2019/0235904 A1
(43) Pub. Date: Aug. 1, 2019

(54) CLONING SERVICES IN VIRTUALIZED COMPUTING SYSTEMS

(71) Applicant: Nutanix, Inc., San Jose, CA (US)

(72) Inventors: Raymon Gerardus Antonius Epping, Bodegraven (NL); Rob Scheepens, Lijnden (NL)

(73) Assignee: Nutanix, Inc., San Jose, CA (US)

(21) Appl. No.: 15/885,758

(22) Filed: Jan. 31, 2018

(51) Int. Cl. G06F 9/455; G06F 3/06

(52) U.S. Cl. CPC G06F 9/45558; G06F 3/0604; G06F 3/065; G06F 3/0664; G06F 2009/4557; G06F 3/064; G06F 2009/45562; G06F 2009/45595; G06F 3/067

(57) ABSTRACT

Examples of virtualized systems are described which may include cloning services. Cloning services described herein may facilitate the generation of cloned virtual machines which may be made available (e.g., run and/or accessed) before all data utilized by the cloned virtual machine had been copied into local storage of the computing node hosting the cloned virtual machine. This may facilitate more expeditious availability of a cloned virtual machine while providing for data transfer at a later time.

### TECHNICAL FIELD

Examples herein relate generally to virtualized computing systems. Examples of systems are described which provide for the cloning of one or more virtual machines. Examples of systems are described which provide for the cloning of one or more virtual machines.

### BACKGROUND

A virtual machine (VM) generally refers to a software-based implementation of a machine in a virtualization environment, in which the hardware resources of a physical computer (e.g., CPU, memory, etc) are virtualized or transformed into the underlying support for the fully functional virtual machine that can run its own operating system and applications on the underlying physical resources just like a real computer.

Virtualization generally works by inserting a thin layer of software directly on the computer hardware or on a host operating system. This layer of software contains a virtual machine monitor or “hypervisor” that allocates hardware resources dynamically and transparently. Multiple operating systems may run concurrently on a single physical computer and share hardware resources with each other. By encapsulating an entire machine, including CPU, memory, operating system, and network devices, a virtual machine may be completely compatible with most standard operating systems, applications, and device drivers. Most modern implementations allow several operating systems and applications to safely run at the same time on a single computer, with each having access to the resources it needs when it needs them.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine may not be utilized to perform useful work. This may be wasteful and inefficient if there are users on other physical machines which are currently waiting for computing resources. Virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

### BRIEF OF DESCRIPTION OF THE DRAWINGS

FIG. 1 is a block diagram of a distributed computing system, arranged in accordance with embodiments described herein.

FIG. 2 is a flowchart of a method to request a clone, arranged in accordance with examples described herein.

FIG. 3 is a flowchart illustrating a method, arranged in accordance with examples described herein.

FIG. 4 is a block diagram of components of a computing node arranged in accordance with examples described herein.

### DETAILED DESCRIPTION

Certain details are set forth herein to provide an understanding of described embodiments of technology. However, other examples may be practiced without various of these particular details. In some instances, well-known circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

Examples described herein may address problems that may arise in distributed (e.g., virtualized) computing systems. For example, it may be desirable to clone a virtual machine in a computing system. A clone may be desired, for example, to support an additional user (e.g., a cloned user virtual machine), to establish a separate environment to test or pilot new software and/or configurations, and/or other reasons. However, virtual machines generally make use of certain data which may be stored in a storage pool of a virtualized computing system. To make a full clone, all the data used by the VM may need to be copied for use by the cloned VM. This process may take too long, delaying availability of the cloned VM and/or creating hotspots where certain VMs become overused, such as during periods awaiting the availability of a cloned VM.

Examples described herein may accordingly provide mechanisms with which the time it takes to create a clone may be reduced. For example, a linked clone may initially be created, making the clone available, while in the background using metadata information (e.g., copy-on-read) to copy the data of the source over to the clone, eventually making it a full done. In this manner, a user may be provided with relatively instant access to the done (e.g., linked clone) without having to wait for a long time while the data is copied (e.g., full clone).

Examples described herein may determine blocks to copy using logic which may otherwise be used for data locality determination. When the complete data is copied, mechanisms like deduplication may be used to reduce storage capacity requirements overall.

In some examples, cloning may be used multiple times to transition an application (e.g., multiple virtual machines) between different stages in an enterprise environment—such as from development (D) to test (T), acceptance (A), production (P), and back. Accordingly, in examples described herein, a user may be able to select whether to create a fast clone (e.g., a linked clone only), an initial-linked clone (e.g., a linked clone which is eventually made into a full clone as described herein), or a full done (e.g., a clone which is unavailable until all data is copied). When the initially-linked clone is suggested, a linked cloned may initially be generated and then in the background the linked clone may be “hydrated.” In some examples, the “hydrating” may occur based on read blocks. For example, the blocks of data to copy may be based on reads made by the cloned application and/or VM. Over time, the initial-linked clone may become a full clone when all the data is copied, either based on read blocks and/or based on a background process copying the data.

In some examples, a user interface may be provided to visualize the status for the clone. A visual representation may be provided of the linked data versus replicated blocks.

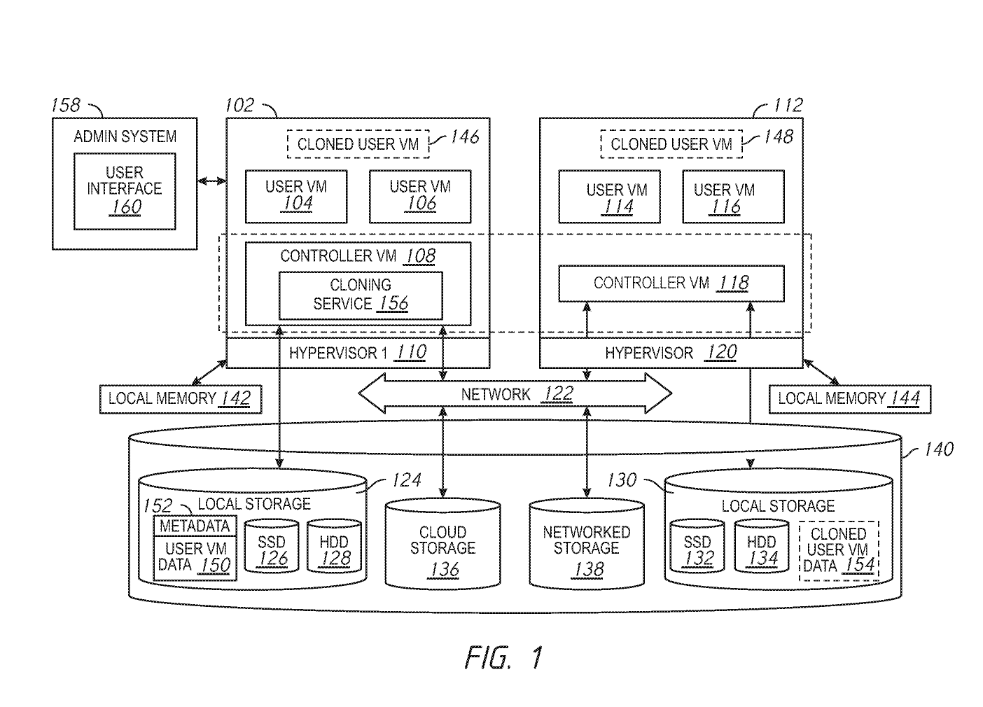

FIG. 1 is a block diagram of a distributed computing system, in accordance with embodiments described herein. The distributed computing system of FIG. 1 generally includes computing node 102 and computing node 112 and storage 140 connected to a network 122. The network 122 may be any type of network capable of routing data transmissions from one network device (e.g., computing node 102, computing node 112, and storage 140) to another. For example, the network 122 may be a local area network (LAN), wide area network (WAN), intranet, Internet, or a combination thereof. The network 122 may be a wired network, a wireless network, or a combination thereof.

The storage 140 may include local storage 124, local storage 130, cloud storage 136, and networked storage 138. The local storage 124 may include, for example, one or more solid state drives (SSD 126) and one or more hard disk drives (HDD 128). Similarly, local storage 130 may include SSD 132 and HDD 134. Local storage 124 and local storage 130 may be directly coupled to, included in, and/or accessible by a respective computing node 102 and/or computing node 112 without communicating via the network 122. Cloud storage 136 may include one or more storage servers that may be stored remotely to the computing node 102 and/or computing node 112 and accessed via the network 122. The cloud storage 136 may generally include any type of storage device, such as HDDs SSDs, or optical drives. Networked storage 138 may include one or more storage devices coupled to and accessed via the network 122. The networked storage 138 may generally include any type of storage device, such as HDDs SSDs, and/or NVM Express (NVMe) devices. In various embodiments, the networked storage 138 may be a storage area network (SAN).The computing node 102 is a computing device for hosting virtual machines (VMs) in the distributed computing system of FIG. 1. The computing node 102 may be, for example, a server computer. The computing node 102 may include one or more physical computing components, such as processors.

The computing node 102 is configured to execute a hypervisor 110, a controller VM 108 and one or more user VMs, such as user VMs 104, 106. The user VMs including user VM 104 and user VM 106 are virtual machine instances executing on the computing node 102. The user VMs including user VM 104 and user VM 106 may share a virtualized pool of physical computing resources such as physical processors and storage (e.g., storage 140). The user VMs including user VM 104 and user VM 106 may each have their own operating system, such as Windows or Linux. While a certain number of user VMs are shown, generally any number may be implemented. User VMs may generally be provided to execute any number of applications which may be desired by a user.

The hypervisor 110 may be any type of hypervisor. For example, the hypervisor 110 may be ESX, ESX(i), Hyper-V, KVM, or any other type of hypervisor. The hypervisor 110 manages the allocation of physical resources (such as storage 140 and physical processors) to VMs (e.g., user VM 104, user VM 106, and controller VM 108) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

Controller VMs (CVMs) described herein, such as the controller VM 108 and/or controller VM 118, may provide services for the user VMs in the computing node. As an example of functionality that a controller VM may provide, the controller VM 108 may provide virtualization of the storage 140. Controller VMs may provide management of the distributed computing system shown in FIG. 1, Examples of controller VMs may execute a variety of software and/or may serve the I/O operations for the hypervisor and VMs running on that node. In some examples, a SCSI controller, which may manage SSD and/or HDD devices described herein, may be directly passed to the CVM, leveraging PCI Passthrough in sonic examples. In this manner, controller VMs described herein may manage input/output (I/O) requests between VMs on a computing node and available storage, such as storage 140.

The computing node 112 may include user VM 114, user VM 116, a controller VM 118, and a hypervisor 120. The user VM 114, user VM 116, the controller VM 118, and the hypervisor 120 may be implemented similarly to analogous components described above with respect to the computing node 102. For example, the user VM 114 and user VM 116 may be implemented as described above with respect to the user VM 104 and user VM 106. The controller VM 118 may be implemented as described above with respect to controller VM 108. The hypervisor 120 may be implemented as described above with respect to the hypervisor 110. In the embodiment of FIG. 1, the hypervisor 120 may be a different type of hypervisor than the hypervisor 110. For example, the hypervisor 120 may be Hyper-V, while the hypervisor 110 may be ESX(i). In some examples, the hypervisor 110 may be of a same type as the hypervisor 120.

The controller VM 108 and controller VM 118 may communicate with one another via the network 122. By linking the controller VM 108 and controller VM 118 together via the network 122, a distributed network of computing nodes including computing node 102 and computing node 112, can be created.

Controller VMs, such as controller VM 108 and controller VM 118, may each execute a variety of services and may coordinate, for example, through communication over network 122. Services running on controller VMs may utilize an amount of local memory to support their operations. For example, services running on controller VM 108 may utilize memory in local memory 142. Services running on controller VM 118 may utilize memory in local memory 144. The local memory 142 and local memory 144 may be shared by VMs on computing node 102 and computing node 112, respectively, and the use of local memory 142 and/or local memory 144 may be controlled by hypervisor 110 and hypervisor 120, respectively. Moreover, multiple instances of the same service may be running throughout the distributed system—e.g. a same services stack may be operating on each controller VM. For example, an instance of a service may be running on controller VM 108 and a second instance of the service may be running on controller VM 118.

Generally, controller VMs described herein, such as controller VM 108 and controller VM 118 may be employed to control and manage any type of storage device, including all those shown in storage 140 of FIG. 1, including local storage 124 (e.g., SSD 126 and HDD 128), cloud storage 136, and networked storage 138, Controller VMs described herein may implement storage controller logic and may virtualize all storage hardware as one global resource pool (e.g., storage 140) that may provide reliability, availability, and performance. IP-based requests are generally used (e.g., by user VMs described herein) to send I/O requests to the controller VMs. For example, user VM 104 and user VM 106 may send storage requests to controller VM 108 using over a virtual bus. Controller VMs described herein, such as controller VM 108, may directly implement storage and I/O optimizations within the direct data access path. Communication between hypervisors and controller VMs described herein may occur using IP requests.

Note that controller VMs are provided as virtual machines utilizing hypervisors described herein—for example, the controller VM 108 is provided behind hypervisor 110. Since the controller VMs run “above” the hypervisors examples described herein may be implemented within any virtual machine architecture, since the controller VMs may be used in conjunction with generally any hypervisor from any virtualization vendor.

Virtual disks (vDisks) may be structured from the storage devices in storage 140, as described herein. A vDisk generally refers to the storage abstraction that may be exposed by a controller VM to be used by a user VM. In some examples, the vDisk may be exposed via iSCSI (“internet small computer system interface”) or NFS (“network file system”) and may be mounted as a virtual disk on the user VM. For example, the controller VM 108 may expose one or more vDisks of the storage 140 and, the hypervisor may attach the vDisks to one or more VMs, and the virtualized operating system may mount a vDisk on one or more user VMs, such as user VM 104 and/or user VM 106.

During operation, user VMs (e.g., user VM 104 and/or user VM 106) may provide storage input/output (I/O) requests to controller VMs (e.g., controller VM 108 and/or hypervisor 110). Accordingly, a user VM may provide an I/O request over a virtual bus to a hypervisor as an iSCSI and/or NFS request. Internet Small Computer system Interface (iSCSI) generally refers to an IP-based storage networking standard for linking data storage facilities together. By carrying SCSI commands over IP networks, iSCSI can he used to facilitate data transfers over intranets and to manage storage over any suitable type of network or the Internet. The iSCSI protocol allows iSCSI initiators to send SCSI commands to iSCSI targets at remote locations over a network. In some examples, user VMs may send I/O requests to controller VMs in the form of NFS requests. Network File system (NFS) refers to an IP-based file access standard in which NFS clients send file-based requests to NFS servers via a proxy folder (directory) called “mount point”. Generally, then, examples of systems described herein may utilize an IP-based protocol (e.g., iSCSI and/or NES) to communicate between hypervisors and controller VMs.

During operation, examples of user VMs described herein may provide storage requests using an IP based protocol, such as SMB. The storage requests may designate the IP address for a controller VM from which the user VM desires I/O services, The storage request may be provided from the user VM to a virtual switch within a hypervisor to be routed to the correct destination. For examples, the user VM 104 may provide a storage request to hypervisor 110. The storage request may request I/O services from controller VM 108 and/or controller VM 118. If the request is to be intended to be handled by a controller VM in a same service node as the user VM (e.g., controller VM 108 in the same computing node as user VM 104) then the storage request may be internally routed within computing node 102 to the controller VM 108. In some examples, the storage request may be directed to a controller VM on another computing node. Accordingly, the hypervisor (e.g., hypervisor 110) may provide the storage request to a physical switch to be sent over a network (e.g., network 122) to another computing node running the requested controller VM (e.g., computing node 112 running controller VM 118).

Accordingly, hypervisors described herein may manage I/O requests between user VMs in a system and a storage pool. Controller VMs may virtualize I/O access to hardware resources within a storage pool according to examples described herein. In this manner, a separate and dedicated controller (e.g., controller VM) may be provided for each and every computing node within a virtualized computing system (e.g., a cluster of computing nodes that run hypervisor virtualization software), since each computing node may include its own controller VM. Each new computing node in the system may include a controller VM to share in the overall workload of the system to handle storage tasks. Therefore, examples described herein may be advantageously scalable, and may provide advantages over approaches that have a limited number of controllers. Consequently, examples described herein may provide a massively-parallel storage architecture that scales as and when hypervisor computing nodes are added to the system.

Examples of controller VMs described herein may include a cloning service, such as cloning service 156. FIG. 1 illustrates cloning service 156 provided by controller VM 108 in computing node 102. In other examples, multiple controller VMs in a computing system may provide cloning services (e.g., controller VM 118 may provide a cloning service). In some examples, there may be a lead cloning service among multiple cloning services in a system which provide coordination and other actions for all cloning services in the system (e.g., interaction with a user interface, etc.).

Cloning services described herein may facilitate the generation of cloned virtual machines which may be made available (e.g., run and/or accessed) before all data utilized by the cloned virtual machine had been copied into local storage of the computing node hosting the cloned virtual machine. This may facilitate more expeditious availability of a cloned virtual machine while providing for data transfer at a later time.

For example, in the example of FIG. 1, the user VM 106 may have user VM data 150 which may be stored in local storage 124. The user VM data 150 may include data utilized by the user VM 106. To clone the user VM 106, the cloning service 156 may clone the user VM 106 to computing node 102, computing node 112, and/or another computing node in the system. For example, the cloning service 156 may provide cloned user VM 146 and/or cloned user VM 148.

When the cloned user VM is provided at another node, for example, when cloning service 156 on computing node 102 provide cloned user VM 148 on computing node 112, the user VM data 150 may desirably be copied to the local storage 130. However, if all the user VM data 150 is copied before making the cloned user VM 148 available for use, there may be a significant delay in availability of the cloned user VM 148. Accordingly, examples of cloning services described herein may provide for creation of a “linked clone” during a time a “full clone” is being created.

For example, the cloning service 156 may clone user VM 106 to provide cloned user VM 148. Rather than copying all of the user VM data 150 to local storage 130, however, the cloning service 156 may provide a link in local storage 130 to the user VM data 150 in local storage 124. In this manner, the cloned user VM 148 may initially become available utilizing the link in the local storage 130. While examples of cloning user VMs are described herein, cloning services described herein may generally clone any virtual machine. Moreover, cloning services described herein, including cloning service 156, may clone applications (e.g., multiple virtual machines operating a particular application).

The cloning service 156 may additionally begin a process of copying the user VM data 150 from the local storage 124 to the local storage 130 to provide cloned user VM data 154. The process of copying the user VM data 150 to the cloned user VM data 154 may occur, for example, using a background process executing during normal operation of the computing system. Data may be copied periodically in batches in some examples.

In this manner, the cloned user VM 148 may initially be available and may utilize a link back to user VM data 150 in local storage 124. For example, when the cloned user VM 148 requests data, the controller VM 118 may access the link stored in local storage 130 and may follow the link back to the local storage 124. In some examples, following the link, the controller VM 118 may request the data (originally requested by the cloned user VM 148) from the controller VM 108 which may in turn access the user VM data 150 in local storage 124 and provide the data to the controller VM 118 for use by cloned user VM 148. Over time, as the user VM data 150 is copied to the cloned user VM data 154 by a background process or otherwise, the link may no longer be used, and the cloned user VM 148 may locally access cloned user VM data 154.

Examples of cloning services described herein may utilize techniques for efficiently copying data from a source computing node hosting a source user VM to a destination computing node hosting a cloned user VM. For example, in addition to or instead of a background process periodically copying amounts of data from the local storage 124 to the local storage 130 for use by the cloned user VM 148, data may be copied responsive to read requests for the data. For example, when the cloned user VM 148 requests data that has not yet been copied from local storage 124 to local storage 130, the controller VM 118 may follow a link in the local storage 130 to direct a request for the data to the controller VM 108 which may access the data in the local storage 124. The cloning service 156 may recognize the request from the link placed by the cloning service 156 in the local storage 130 and may direct the controller VM 108 to not only return the requested data but also copy the requested data from the local storage 124 to the local storage 130. In this manner, data actually, requested by a cloned virtual machine may be copied from the local storage of the host computing node to the local storage of the destination computing node responsive to the request. Accordingly, frequently used data may be copied earlier in the process than would otherwise occur through periodic copying of amounts of data.

In some examples, cloning services described herein may clone a user VM within a same computing node. For example, the cloning service 156 may clone user VM 106 to cloned user VM 146, both hosted by computing node 102. Accordingly, it may not be necessary to copy user VM data 150 from local storage 124 to another computing nodes' local storage instead, the cloning service 156 may update metadata (e.g., metadata 152) associated with the user VM data 150 to indicate that the user VM data 150 is for use by the cloned user VM 146.

Examples of systems described herein may include one or more administrator systems, such as admin system 158 of FIG. 1. The administrator system may be implemented using, for example, one or more computers, servers, laptops, desktops, tablets, mobile phones, or other computing systems. In some examples, the admin system 158 may be wholly and/or partially implemented using one of the computing nodes of a distributed computing system described herein. However, in some examples (such as shown in FIG. 1), the admin system 158 may be a different computing system from the virtualized system and may be in communication with a CVM of the virtualized system (e.g., controller VM 108 of FIG. 1) using a wired or wireless connection (e.g., over a network).

Administrator systems described herein may host one or more user interfaces, e.g., user interface 160. The user interface may be implemented, for example, by displaying a user interface on a display of the administrator system. The user interface may receive input from one or more users (e.g., administrators) using one or more input device(s) of the administrator system, such as, but not limited to, a keyboard, mouse, touchscreen, and/or voice input. The user interface 160 may provide the input to controller VM 108 (e.g., to the cloning service 156). The input may be used to provide a request to clone a user VM as described herein. The input may identify one or more source computing node(s), destination computing node(s), user VM(s), and/or applications (e.g., multiple user VMs) to clone. While the request may specify a source computing node and a destination computing node, in some examples, the cloning service 156 may itself identify a source computing node based on a request identifying a user VM for cloning. In some examples, the cloning service 156 may itself select a destination computing node based, for example, on resource usage metrics across computing nodes of the distributed system.

The user interface 160 may be implemented, for example, using a web service provided by the controller VM 108 or one or more other controller VMs described herein. In some examples, the user interface 160 may be implemented using a web service provided by controller VM 108 and information from controller VM 108 (e.g., from cloning service 156) may be provided to controller VM 108 for display in the user interface 160.

In some examples, the user interface 160 may provide a user with multiple options for how to conduct a requested clone. For example, a user may select through the user interface 160 to conduct a “linked clone only,” “full clone,” or an “initially-linked clone.” The selection may be made, for example, by clicking, highlighting, and/or otherwise selecting an option displayed on the user interface 160. Responsive to a request to clone a VM using the “full clone” option, the cloning service 156 may clone a requested VM and may conduct a complete copy of the VM data from the local storage of the source computing node to the local storage of the destination computing node before bringing up the cloned VM (e.g., before making the cloned VM available). Responsive to a request to clone a VM using the “linked clone only” option, the cloning service 156 may create a link to the user VM data 150 and take no further action to copy data from local storage 124 to the local storage 130. Responsive to a request to clone a VM using the “initially-linked clone” option, the cloning service 156 may proceed as described herein, providing a cloned VM and a link at the destination computing node to the VM data at the source computing node, and initiating a background process to copy the VM data to the local storage of the destination computing node over time. The acts of copying the VM data to the local storage of the destination computing node may be referred to as “hydration” of the linked clone. In some examples, as described herein, the cloning service 156 may utilize efficient techniques for conducting the copying, including copying selected data responsive to read requests received for selected data.

In some examples, the user interface 160 may display a status of one or more cloning procedures described herein. For example, the user interface 160 may display a visual representation of the status of a clone, which may include, for example, a visual identification of which blocks of VM data have been copied from the source computing node to the destination computing node. In this manner, a user may be more readily able to ascertain whether background copying of the VM data is still occurring, or if the full clone has been instantiated on the destination computing node including a complete copy of the VM data.

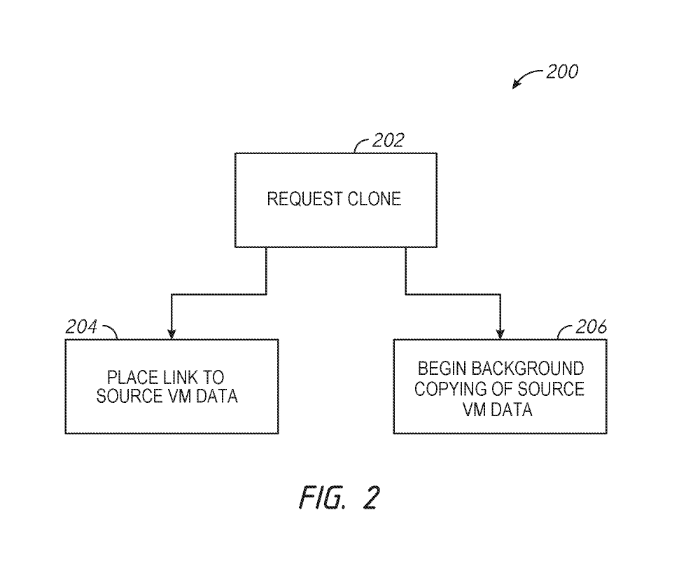

FIG. 2 is a flowchart of a method to request a clone, arranged in accordance with examples described herein. The method includes block 202, which recites “request clone,” block 204 which recites “place link to source VM data” and block 206 which recites “begin background copying of source VM data.”

In block 202, a clone may be requested. For example, referring to FIG. 1, a user may request a clone using user interface 160 of admin system 158. In some examples, a clone may be requested by another computing process. In some examples, a controller VM described herein may request a clone based on user input and/or resource usage status in the computing system. The request in block 202 may be received by a cloning service described herein, such as cloning service 156 of FIG. 1. The request provided in block 202 may identify what virtual machine(s) to clone—for example, the request may pertain to a user virtual machine and/or an application (e.g., multiple virtual machines). Other virtual machines may be cloned in other examples. The request provided in block 202 may indicate a number of clones requested—e.g., 1, 2, 3, 4, 5, 6, 7, 8, 9, 10, and/or a different number of clones of a particular VM and/or application may be requested. In some examples, the request provided in block 202 may specify a source computing node of a distributed system currently hosting the VM desired to be cloned. In some examples, the request provided in block 202 may specify a destination computing node of a distributed system onto which to clone the requested VM and/or application. In other examples, however, the request itself may not identify the source and/or destination computing node. The source and/or destination computing node may be identified responsive to the request, such as by a cloning service described herein.

In some examples, a user may select from multiple options regarding how to conduct the clone. For example, a user may specify (e.g., by selecting between multiple displayed choices), whether to conduct a linked clone only, a full clone or an initially-linked clone. When the request in block 202 is to conduct a full clone, the cloning service 156 may conduct a complete copy of data used by the VM to be cloned from the source computing node to the destination computing node. When the request in block 202 is to conduct a linked clone only, the block 204 may be performed, but the block 206 may not be performed. When the request in block 202 is to conduct an initially linked clone, block 204 and block 206 may be performed.

In block 204, a link to source VM data is placed at the destination computing node. For example, a cloning service described herein (e.g., cloning service 156) may place a link in local storage of the destination computing node pointing to the VM data for the cloned VM in the local storage of the source computing node. In this manner, the cloned VM may be available as soon as the VM itself is cloned and the link is placed. This may be faster than waiting for a complete copy of the VM data to be provided at the destination computing node,

In block 206, which may occur at least in part in parallel with block 204 and/or may occur after block 204, background copying of the VM data from the source computing node to the destination computing node may begin. For example, a cloning service described herein (e.g., cloning service 156) may begin copying VM data from local storage of a source computing node to local storage of a destination computing node. The copying may occur periodically (e.g., an amount of data may be copied each time period). The amount of copying and/or the time periods may vary based in some examples on the load in the distributed computing system. For example, data copying may be slowed and/or delayed during times of higher load in the distributed computing system to avoid affecting performance of the distributed computing system as a whole. In some examples, additional techniques may be used (e.g., by cloning services described herein) to efficiently perform the copying. For example, cloning services described herein may copy selected data to the destination computing node responsive to a request for that data from the cloned virtual machine. In this manner, more frequently used data may be copied earlier than would otherwise be scheduled by the background copying process.

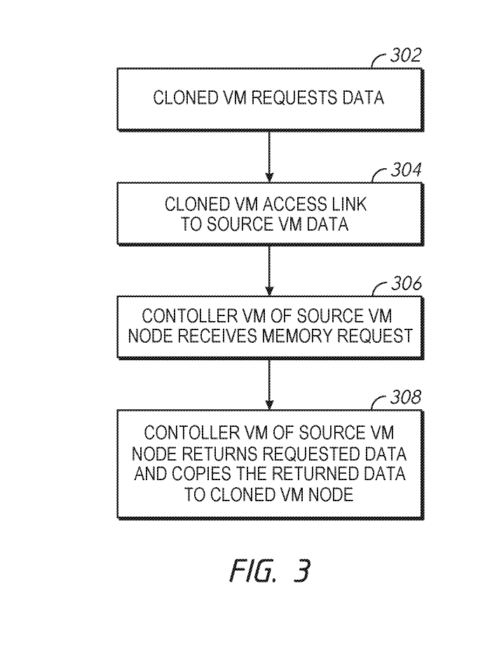

FIG. 3 is a flowchart illustrating a method arranged in accordance with examples described herein. The method of FIG. 3 includes block 302 which recites “cloned VM requests data”. Block 302 may be followed by block 304 which recites “cloned VM accesses link to source VM data.” Block 304 may be followed by block 306 which recites “controller VM of source VM node receives memory request.” Block 306 may be followed by block 308 which recites “controller VM of source VM node returns requested data and copies the returned data to cloned VM node.”

The method of FIG. 3 may accordingly provide a mechanism for efficiently copying data from a source computing node to a destination computing node for a cloned VM. For example, in addition to or instead of periodically copying an amount of data from the source computing node to the destination computing node, data may be copied as it is accessed by the cloned VM. This may advantageously allow for more frequently used data to be copied sooner than may be scheduled if the data copying were performed without regard to data accesses.

In block 302, a cloned VM may request data. For example, the cloned user VM 146 and/or cloned user VM 148 of FIG. 1 may provide a request for particular data. Prior to cloning, the data resided at user VM data 150 in local storage 124. Recall at the time of cloning the cloned user VM 148, a link may be placed in local storage 130 pointing to the user VM data 150 in local storage 124 (see, e.g., block 204 of FIG. 2). When the cloned user VM 148 provides a request for data in block 302, the request for data may be provided to a controller VM of the destination computing node, such as controller VM 118 of Figure

If the requested data had already been copied from the local storage of the source computing node to the local storage of the destination computing node, the cloned VM may access the data from the local storage of the destination computing node For example, when the requested data has been copied from user VM data 150 of FIG. 1 to cloned user VM data 154 of FIG. 1, the cloned user VM 148 may access the data in the cloned user VM data 154. For example, the data may have already been copied by the background process referred to in block 206 of FIG. 2.

However, if the requested data had not yet been copied from the local storage of the source computing node to the local storage of the destination computing node, the request in block 302 may result in the cloned VM accessing the link to the source VM data. For example, the cloned user VM 148 may access a link in local storage 130 which points to the user VM data 150 in local storage 124. The access may be managed by a controller VM (e.g., controller VM 118 of FIG. 1). Following the link may result in a data request being provided to the controller VM of the source computing node in block 306. For example, the controller VM 118 of FIG. 1 may, responsive to accessing the link, provide the data request to the controller VM 108 of FIG. 1 to access the user VM data 150 in local storage 124.

The controller VM of the source computing node (e.g., the controller VM 108 of FIG. 1) may return the data to the requesting controller VM (e.g., the controller VM 118 of FIG. 1). In addition to returning the data, however, the controller VM of the source computing node may additionally copy the requested data to the local storage of the destination computing node (e.g., to the local storage 130 of FIG. 1). By copying data responsive to requests for the data (e.g., read requests), examples described herein may provide for more expedient availability of frequently-used data at cloned VMs.

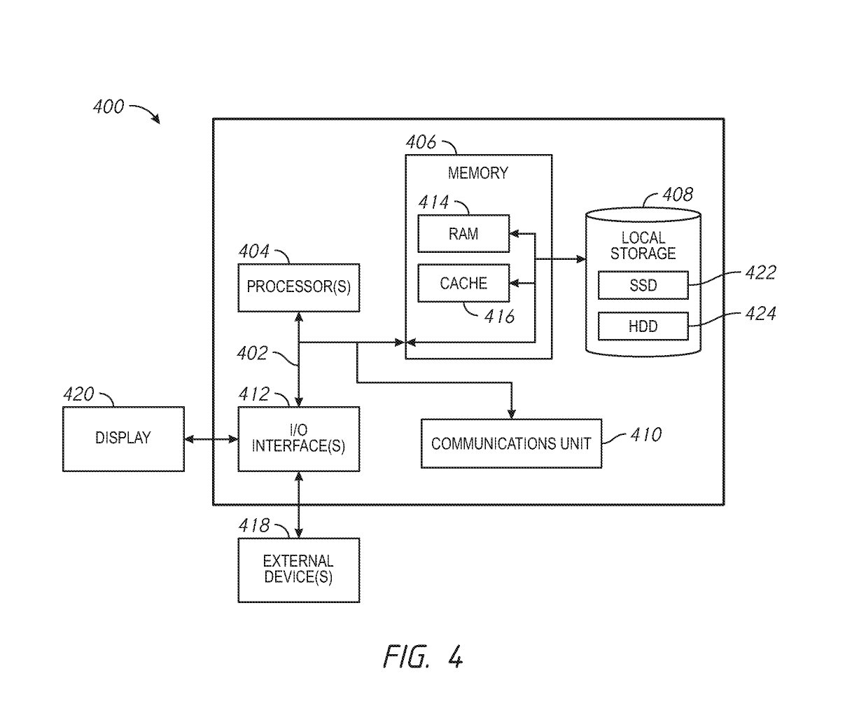

FIG. 4 depicts a block diagram of components of a computing node 400 in accordance with an embodiment of the present invention. It should be appreciated that FIG. 4 provides only an illustration of one implementation and does not imply any limitations with regard to the environments in which different embodiments may be implemented. Many modifications to the depicted environment may be made. The computing node 400 may implemented as the computing node 102 and/or computing node 112.

The computing node 400 includes a communications fabric 402, which provides communications between one or more processor(s) 404, memory 406, local storage 408, communications unit 410, I/O interface(s) 412. The communications fabric 402 can be implemented with any architecture designed for passing data and/or control information between processors (such as microprocessors, communications and network processors, etc.), system memory, peripheral devices, and any other hardware components within a system. For example, the communications fabric 402 can be implemented with one or more buses.

The memory 406 and the local storage 408 are computer-readable storage media. In this embodiment, the memory 406 includes random access memory RAM 414 and cache 416. In general, the memory 406 can include any suitable volatile or non-volatile computer-readable storage media. The local storage 408 may be implemented as described above with respect to local storage 124 and/or local storage 130. In this embodiment, the local storage 408 includes an SSD 422 and an HDD 424, which may be implemented as described above with respect to SSD 126, SSD 132 and HDD 128, HDD 134 respectively.

Various computer instructions, programs, files, images, etc. may be stored in local storage 408 for execution by one or more of the respective processor(s) 404 via one or more memories of memory 406, in some examples, local storage 408 includes a magnetic HDD 424. Alternatively, or in addition to a magnetic hard disk drive, local storage 408 can include the SSD 422 a semiconductor storage device, a read-only memory (ROM), an erasable programmable read-only memory (EPROM), a flash memory, or any other computer-readable storage media that is capable of storing program instructions or digital information.

The media used by local storage 408 may also be removable. For example, a removable hard drive may be used for local storage 408. Other examples include optical and magnetic disks, thumb drives, and smart cards that are inserted into a drive for transfer onto another computer-readable storage medium that is also part of local storage 408.

Communications unit 410, in these examples, provides for communications with other data processing systems or devices. In these examples, communications unit 410 includes one or more network interface cards. Communications unit 410 may provide communications through the use of either or both physical and wireless communications links.

I/O interface(s) 412 allows for input and output of data with other devices that may be connected to computing node 400. For example, I/O interface(s) 412 may provide a connection to external device(s) 418 such as a keyboard, a keypad, a touch screen, and/or some other suitable input device. External device(s) 418 can also include portable computer-readable storage media such as, for example, thumb drives, portable optical or magnetic disks, and memory cards. Software and data used to practice embodiments of the present invention can be stored on such portable computer-readable storage media and can be loaded onto local storage 408 via I/O interface(s) 412. I/O interface(s) 412 also connect to a display 420.

Display 420 provides a mechanism to display data to a user and may be, for example, a computer monitor.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signals may be provided directly to and/or received directly from the recited components without intervening components, but also may be provided to and/or received from the certain components through intervening components.

1. A method comprising:
receiving, at a controller virtual machine of a source computing node of a computing node cluster, a request to clone a user virtual machine hosted on the source computing node, wherein the source computing node comprises local memory configured to store data for the user virtual machine;
cloning the user virtual machine to a destination computing node of the computing node cluster to provide a cloned user virtual machine;
placing, in local storage of the destination computing node, a link to a location within the local storage of the source computing node storing the data of the user virtual machine; and
beginning a background process of copying the data of the user virtual machine from the local storage of the source computing node to the local storage of the destination computing node, wherein a controller virtual machine of the destination computing node is configured to use the link to access the data of the user virtual machine until the data is copied to the local storage of the destination computing node.

2. The method of claim 1, further comprising:
accessing, by the controller virtual machine of the destination computing node, the link to the data of the user virtual machine responsive a request for at least a portion of the data of the user virtual machine received from the cloned user virtual machine; and
following the link to request the at least the portion of the data from the location within the local storage of the source computing node via the controller virtual machine of the source computing node.

3. The method of claim 2, wherein the request for the data is made prior to the data being copied to the local storage of the destination computing node by the background process.

4. The method of claim 2, further comprising:
providing, by the controller virtual machine of the source computing node, the at least the portion of the data; and
copying the at least the portion of the data from the local storage of the source computing node to the local storage of the destination computing node responsive to the providing.

5. The method of claim 1, further comprising:
displaying, in a user interface, a visual representation of status of the clone of the user virtual machine, status of the background process of copying the data, or combinations thereof.

6. The method of claim 5, wherein the visual representation includes a representation of which blocks of the data of the user virtual machine have been replicated to the local memory of the destination computing node.

7. The method of claim 1, wherein the request is received through a user interface presenting an option to clone the user virtual machine according to the method of claim 1 or to clone utilizing a full clone wherein, utilization of the full clone includes copying of the data of the user virtual machine to the local memory of the destination computing node prior to availability of the cloned user virtual machine.

8. At least one non-transitory computer-readable storage medium including instructions that when executed by a source computing node in a distributed computing system, cause the source computing node to:
receive, at a controller virtual machine of the source computing node, a request to clone a user virtual machine hosted on the source computing node, wherein the source computing node comprises local memory configured to store data for the user virtual machine;
clone the user virtual machine to a destination computing node of the distributed computing system to provide a cloned user virtual machine;
placing, in local storage of the destination computing node, a link to a location within the local storage of the source computing node storing the data of the user virtual machine; and
beginning a background process of copying the data of the user virtual machine from the local storage of the source computing node to the local storage of the destination computing node wherein a controller virtual machine of the destination computing node is configured to use the link to access the data of the user virtual machine until the data is copied to the local storage of the destination computing node.

9. The at least one computer-readable storage medium of claim 8, wherein the instructions further cause the source computing node to:
receive, at the controller virtual machine of the source computing node, a request for at least a portion of the data of the user virtual machine from the cloned user virtual machine, from a controller virtual machine of the destination computing node responsive to an access of the link.

10. The at least one computer-readable storage medium of claim 9, wherein the request for the at least a portion of the data is made prior to the data being copied to the local storage of the destination computing node by the background process.

11. The at least one computer-readable storage medium of claim 9, wherein the instructions further cause the source computing node to:
provide, by the controller virtual machine of the source computing node, the least a portion of the data; and
copy the at least a portion of the data from the local storage of the source computing node to the local storage of the destination computing node responsive to said provide.

12. The at least one computer-readable storage medium of claim 8, wherein the instructions further cause the source computing node to:
display, in a user interface, a visual representation of status of the clone of the user virtual machine, status of the background process of copying the data, or combinations thereof.

13. The at least one computer-readable storage medium of claim 12, wherein the visual representation includes a representation of which blocks of the data of the user virtual machine have been replicated to the local memory of the destination computing node.

14. A system comprising:
a storage pool;
a source computing node configured to host a user virtual machine and a source controller virtual machine, wherein the source computing node includes source local storage configured to store data for the user virtual machine; and
a destination computing node configured to host a destination controller virtual machine and comprising destination local storage; and
wherein the source controller virtual machine includes a cloning service configured to receive a request to clone the user virtual machine, and, responsive to the request, to:
provide a clone of the user virtual machine on the destination computing node; and
place, in the destination local storage, a link to a location within the source local storage to the data for the user virtual machine, wherein the link is configured to be used by the destination controller virtual machine to access the data for the user virtual machine at the source local storage based on a request from the clone of the user virtual machine.

15. The system of claim 21, wherein the destination controller virtual machine is configured to receive the request for at least a portion of the data for the user virtual machine from the cloned clone of the user virtual machine and to access the link to the data for the virtual machine responsive to the request.

16. The system of claim 15, wherein the request is made prior to the data for the virtual machine being copied from the source local storage to the destination local storage.

17. The system of claim 15, wherein the source controller virtual machine is configured to provide the at least a portion of the data responsive to the request for the at least a portion of the data and to copy the at least a portion of the data from the source local storage to the destination local storage responsive to the request for the at least a portion of the data.

18. The system of claim 14, further comprising an admin system, the admin system configured for communication with the source computing node, the admin system further configured to provide a user interface a visual representation of a status of the clone of the at least one virtual machine.

19. The system of claim 18, wherein the visual representation includes a representation of which blocks of the data for the user virtual machine have been replicated to the local storage of the destination computing node.

20. The system of claim 18, wherein the user interface is configured to present an option to clone the virtual machine by providing the link or to clone utilizing a full clone, wherein utilization of the full clone includes copying of the data for the user virtual machine to the destination local storage prior to availability of the cloned user virtual machine.

21. The system of claim 14, wherein, responsive to the request, the source controller virtual machine is further configured to begin a background process of copying the data for the user virtual machine from the source local storage to the destination local storage.
